(19) United States
(12) Patent Application Publication
(10) Pub. No.: US 2019/0261573 A1
(43) Pub. Date: Aug. 29, 2019

(54) GARDENING SHEAR

(71) Applicant: Shih-Piao Wu, Changhua (TW)

(72) Inventor: Shih-Piao Wu, Changhua (TW)

(73) Assignee: JIIN HAUR INDUSTRIAL CO.,LTD., CHANGHUA (TW)

(21) Appl. No.: 15/905,560

(22) Filed: Feb. 26, 2018

(51) Int. Cl. A01G 3/00; B25G 1/10

(52) U.S. Cl. CPC A01G 3/00; B25G 1/102

(57) ABSTRACT

A gardening shear may comprise a main body and two grip bodies. The main body has a pair of blades, and each of the blades is connected to a handle at a rear end thereof. The two blades are pivotally connected to enable a user to operate the handles to cut plants through the blades. Each of the handles comprises a couple surface and a locating end, and the couple surface is shaped and formed ergonomically. Each of the couple surfaces is configured to receive and connect to the grip body, and the locating end located at a rear portion of the handle has at least a protruding edge thereon. When each of the grip bodies is connected to the couple surface of the handle, the protruding edge is configured to engage with and firmly secure the grip body on the handle.

### FIELD OF THE INVENTION

The present invention relates to a gardening shear and more particularly to a durable gardening shear.

### BACKGROUND OF THE INVENTION

Generally, a conventional gardening shear comprises a pair of blades, and each of the blades is connected to a handle. Moreover, each of the blades has a through hole at a middle portion thereof, and the two through holes are configured to be aligned and penetrated by a screw. The screw is adapted to a pivot of the two blades to enable a user to operate the handles to cut plants through blades. Also, for convenient to use, each of outer peripheries of the handles is generally connected to or covered by a grip cover so as to achieve the anti-slip or soft-touch effect.

However, the conventional gardening shear is disadvantageous because: each of the grip covers only covering or connected to the outer periphery of the handle is not durable and prone to be detached from the handle after a period of time use. Therefore, there remains a need for a new and improved design for a gardening shear to overcome the problems presented above.

### SUMMARY OF THE INVENTION

The present invention provides a gardening shear which comprises a main body and two grip bodies. The main body has a pair of blades, and each of the blades is connected to a handle at a rear end thereof. The two blades are pivotally connected to enable a user to operate the handles to cut plants through the blades. Moreover, each of the handles comprises a couple surface and a locating end, and the couple surface is shaped and formed ergonomically. Each of the couple surfaces is configured to receive and connect to the grip body, and the locating end located at a rear portion of the handle has at least a protruding edge thereon. When each of the grip bodies is connected to the couple surface of the handle, the protruding edge is configured to engage with and firmly secure the grip body on the handle.

Comparing with conventional gardening shear, the present invention is advantageous because: each of the handles has the protruding edge on the locating end which enables the grip body to firmly secure on the couple surface of the handle. Thus, a user has no need to worry about the grip detaching from the locating end, and the gardening shear are more durable for use.

### BRIEF DESCRIPTION OF THE DRAWINGS

FIG. 1 is a three-dimensional assembly view of a gardening shear of the present invention.

FIG. 2 is a three-dimensional exploded view of the gardening shear of the present invention.

FIG. 3 is a schematic view illustrating each of two grip bodies is connected to a handle of the gardening shear in the present invention.

FIG. 4 is a plan view of the gardening shear of the present invention after the grip bodies are respectively connected to the handles.

FIG. 5 is a sectional view of FIG. 4 along line A-A.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

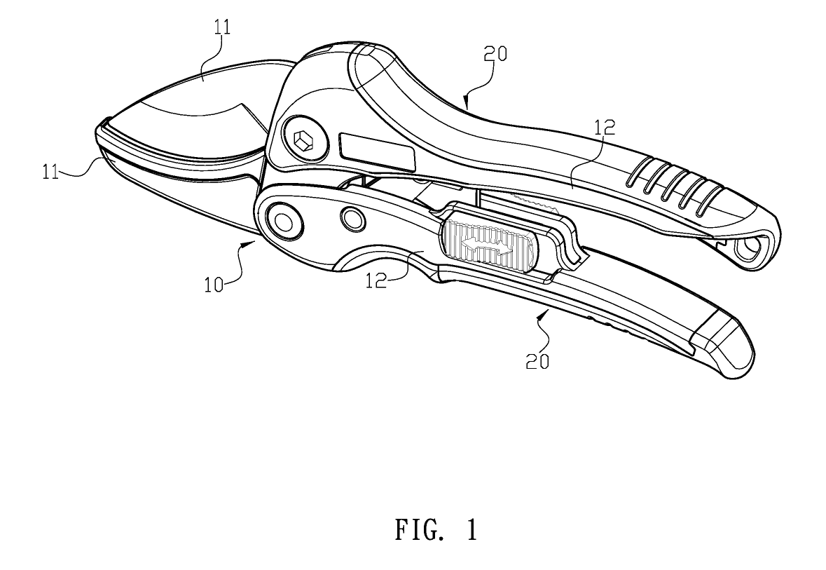

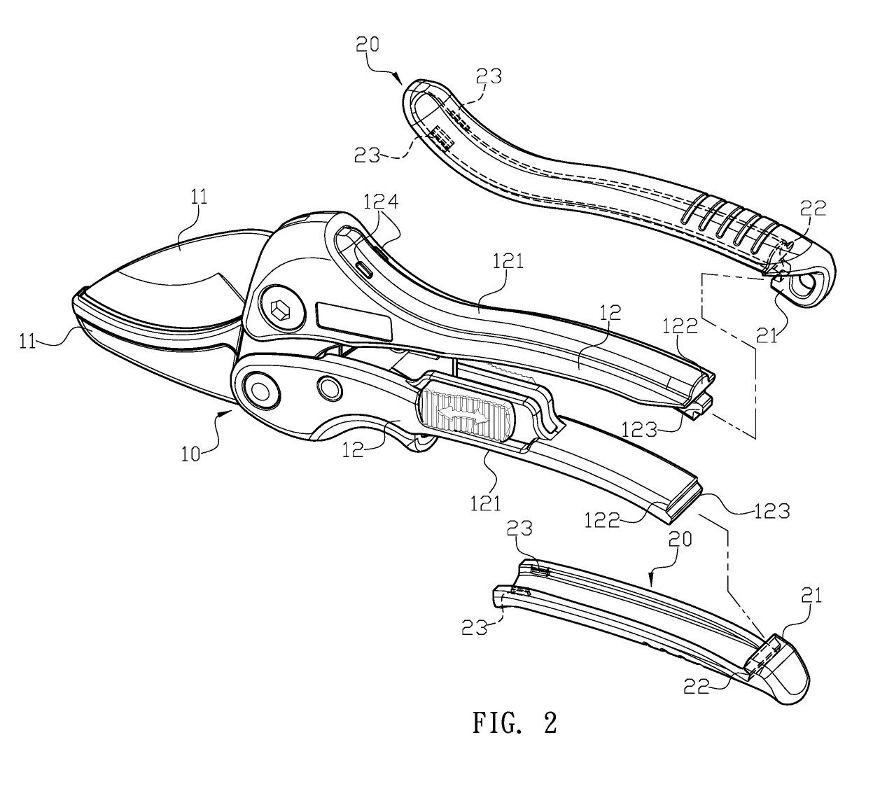

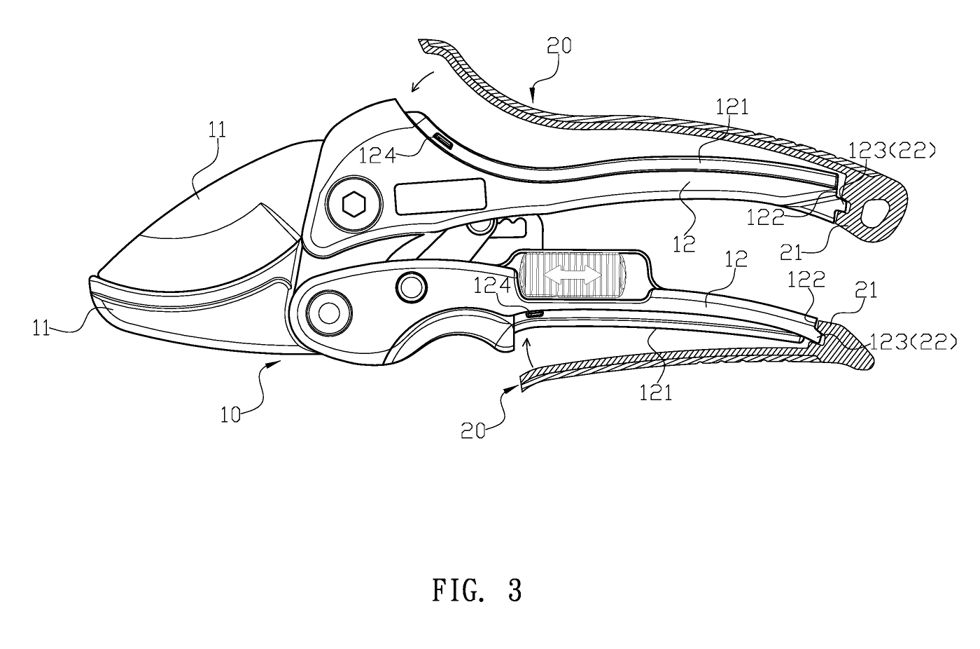

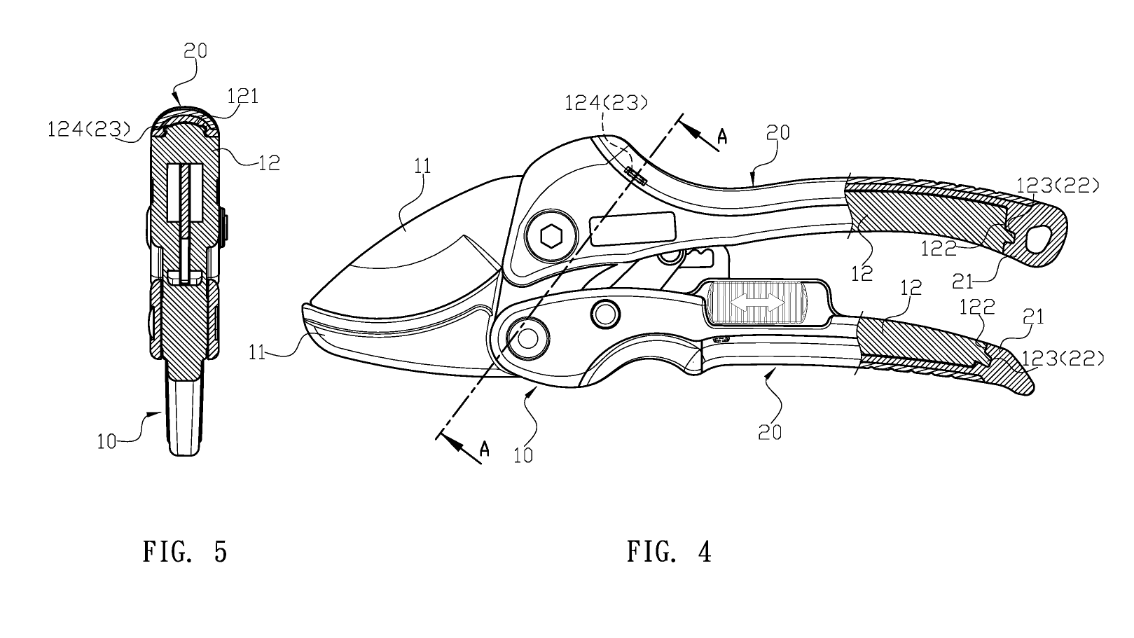

Referring to FIGS. 1 to 5, the present invention provides a gardening shear which comprises a main body (10) and two grip bodies (20). The main body (10) has a pair of blades (11), and each of the blades (11) is connected to a handle (12) at a rear end thereof. The two blades (11) are pivotally connected to enable a user to operate the handles (12) to cut plants through the blades (11). Moreover, each of the handles (12) comprises a couple surface (121) and a locating end (122), and the couple surface (121) is shaped and formed ergonomically. Each of the couple surfaces (121) is configured to receive and connect to the grip body (20), and the locating end (122) located at a rear portion of the handle (12) has at least a protruding edge (123) thereon. When each of the grip bodies (20) is connected to the couple surface (121) of the handle (12), the protruding edge (123) is configured to engage with and firmly secure the grip body (20) on the handle (12).

In one embodiment, one of the blades (11) is replaced with a blade anvil.

In another embodiment, each of the grip bodies (20) is configured to directly and securely cover on the handle (12) through a method of plastic injection.

In still another embodiment, the handle (12) and the grip body (20) are configured to be manufactured individually and connected thereafter; each of the grip bodies (20) has a protruding portion (21) formed at a rear portion thereof, and the protruding portion (21) comprises at least a connecting slot (22) thereon; each of the couple surfaces (121) of the handles (12) has at least an engaging block (124) while each of the grip bodies (20) comprises at least an engaging slot (23); when the grip body (20) is connected to the handle (12), the connecting slot (22) is adapted to engage with the protruding edge (123) first, and the grip body (20) is pressed toward the handle to enable the engaging slot (23) to be engaged with the engaging block (124).

Comparing with conventional gardening shear, the present invention is advantageous because: each of the handles (12) has the protruding edge (123) on the locating end (122) which enables the grip body (20) to firmly secure on the couple surface (121) of the handle (12). Thus, a user has no need to worry about the grip (20) detaching from the locating end (122), and the gardening shear are more durable for use.

Having described the invention by the description and illustrations above, it should be understood that these are exemplary of the invention and are not to be considered as limiting. Accordingly, the invention is not to be considered as limited by the foregoing description, but includes any equivalents.

1. A gardening shear comprising a pair of blades pivotally connected to each other and a pair of grip bodies,
wherein each of the blades is connected to a respective handle at a rear end thereof; the two blades are pivotally connected to enable a user to operate the handles to cut plants through the blades; and
wherein each handle comprises a conjugating surface and a locating end, and each of the conjugating surfaces is configured to receive and connect to the respective grip body, and the locating end located at a rear portion of the handle has at least a protruding edge thereon; when each of the grip bodies is connected to the conjugating surface of the handle, the protruding edge is configured to engage with and firmly secure the grip body on the handle,
wherein each grip body has a protruding portion formed at a rear portion thereof, and the protruding portion comprises at least a connecting slot thereon; each conjugating surface of the respective handle has at least an engaging block while each grip body comprises at least an engaging slot; when the grip body is connected to the respective handle, the connecting slot is adapted to engage with the protruding edge first and the protruding edge is fully received inside the connecting slot, and the grip body is pressed toward the respective handle to enable the engaging slot to be engaged with the engaging block.

2. (canceled)

3. (canceled)

4. The gardening shear of claim 1, wherein the handle and the grip body are configured to be manufactured individually and connected thereafter.
